(19) United States
(12) Patent Application Publication
(10) Pub. No.: US 2007/0209862 A1
(43) Pub. Date: Sep. 13, 2007

(54) Steering system with hollow shaft electric motor and intermediate transmission

(76) Inventors: Martin Budaker, Heubach (DE); Guenther Breu, Iggingen (DE); Andreas Lay, Schwaebisch Hall (DE); John Hasenclever, Aidlingen (DE); Michael Hauck, Remshalden (DE)

Correspondence Address: JORDAN AND HAMBURG LLP, 122 EAST 42ND STREET, SUITE 4000, NEW YORK, NY, 10168, US

(21) Appl. No.: 11/711,585

(22) Filed: Feb. 26, 2007

(30) Foreign Application Priority Data
Feb. 27, 2006 (DE) 10 2006 008 911.1

(51) Int. Cl. B62D 5/04

(52) U.S. Cl. 180/444

(57) ABSTRACT

A steering system with an electric motor includes a hollow shaft through which a rod is passed, the rod being drivable in the longitudinal direction by the electric motor through a worm gear. An intermediate transmission is provided, which reduces the rpm of the electric motor. The hollow shaft is connected torque-proof with a driving outer contour, which transfers torque to the intermediate transmission. The intermediate transmission has a first gear wheel, an axle of which is supported so as to be stationary, and the outer contour of which transfers torque. The worm of the worm gear is formed on the rod. A nut of the worm gear is drivable by the intermediate transmission. For greater economy of construction of the steering system, a second gear wheel with a torque-transferring outer contour, connected over an intermediate shaft torque-proof with the first gear wheel. The intermediate transmission transfers torque to an outer contour, which is connected torque-proof with the nut.

### BACKGROUND OF THE INVENTION

The invention relates to a steering system in which a rod is longitudinally displaceable by a worm gear driven by torque transmitted from an electric motor through an intermediate transmission.

A generic steering system is known from DE 37 35 517 A1.

The generic publication describes a steering system with an electric motor, including a hollow shaft through which a push rod is passed, which is intended to steer the rear wheels of a passenger vehicle. This rod is driven in the longitudinal direction by the electric motor over a planetary transmission (functioning as an intermediate transmission) and a worm gear.

Planetary transmissions are expensive and therefore extravagant, since they contain a relatively large number of components and require special measures for reducing clearance. Moreover, the efficiency of planetary transmissions is not high and such transmissions tend to develop noise.

It is therefore an object of the present invention to create a relatively compact steering system with a worm gear, which is inexpensive to produce.

### SUMMARY OF THE INVENTION

This objective is accomplished by a steering system which includes an electric motor including a hollow shaft. A rod is provided which passes through the hollow shaft. A worm gear includes a worm which is carried on the rod, and a nut having a nut outer contour connected torque-proof therewith for receiving torque. An intermediate transmission is provided which is operable to reduce an rpm of the electric motor, the hollow shaft being connected torque-proof with a driving outer contour which transfers torque to the intermediate transmission. The intermediate transmission includes a first gear wheel having a first gear wheel outer contour to which torque from the driving outer contour is transferred, and a second gear wheel connected torque-proof with the first gear wheel, and having a second gear wheel outer contour that transfers torque to the nut outer contour. The first and second gear wheels have an axle which is essentially stationary relative to a housing part of the steering system, such that the nut of the worm gear is drivable by the intermediate transmission to drive the rod in two longitudinal directions thereof by the electric motor acting through the intermediate transmission and the worm gear.

The steering system according to the invention can be adapted particularly easily to the requirements of a front wheel steering system. An electric motor with a low moment of inertia may be used. The space required is relatively small. The steering system may be part of a power-assisted steering system or a fully hydraulic steering system, and requires relatively few simple intermediate transmission parts. This improves reliability and makes for a quieter operation. In particular, expensive internal toothing and a bezel gear are not required.

Preferably, the worm gear is constructed as a roll body worm gear (roller gear or ball-and-nut gear).

The intermediate transmission may be comprised of a belt and chain drive (especially a toothed pulley drive), or of a cylindrical gear, or a combination of both. It may be two-stage or multi-stage and, in any case, stepping down.

In order to reduce noise, it is advantageous to produce at least one of the external contours (at the hollow shaft, at the nut of the worm gear, at a gear wheel), at least at the surface, from an elastic material, if it is constructed as an external gearing.

Examples of the invention are shown diagrammatically below by means of the drawings.

### BRIEF DESCRIPTION OF THE DRAWINGS

FIG. 1 is a diagrammatic representation of a first example according to the invention with a belt and chain drive as intermediate transmission;

FIG. 2 is a diagrammatic representation of a second example according to the invention with an intermediate transmission with one-piece transmission wheels, which are connected to one another;

FIG. 3 is a diagrammatic representation of a third example according to the invention with a cylindrical gear as intermediate transmission; and

FIG. 4 is a diagrammatic representation of a fourth example according to the invention, for which the intermediate transmission consists of a mixed form of a belt and chain drive and a cylindrical gear

### DETAILED DESCRIPTION OF THE INVENTION

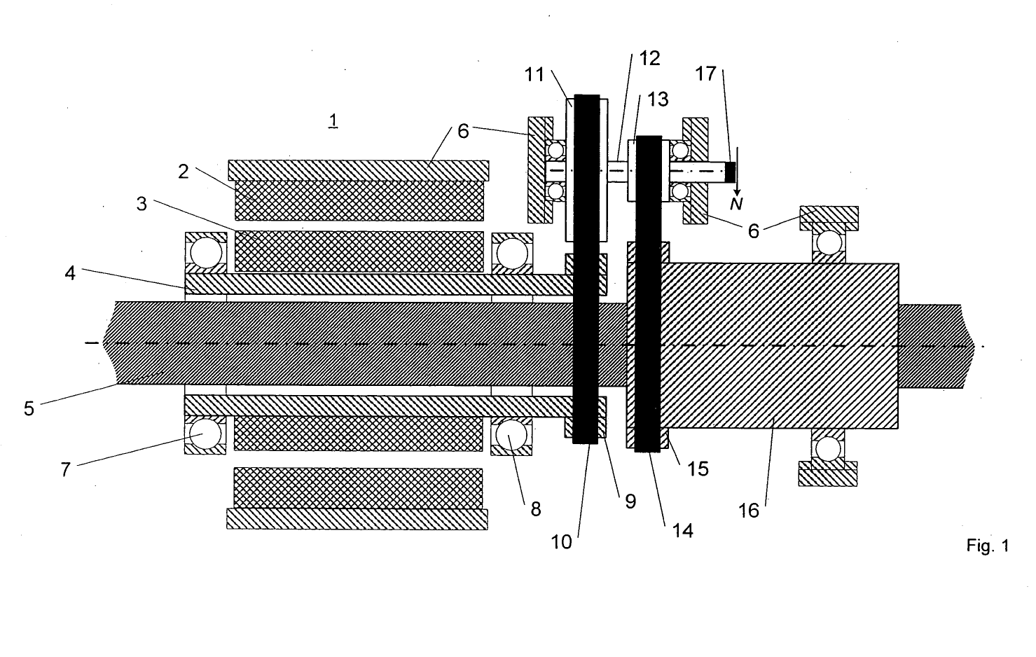

FIG. 1 shows a preferred example, for which the intermediate transmission is constructed as a belt and chain transmission. An electric motor 1 with stator 2 and rotor 3 is constructed as a hollow shaft motor with a hollow shaft 4, and which is coaxial with a rod 5, which can be shifted directly by the electric motor in the two longitudinal directions of the rod 5 and (when used within a power-assisted steering system) may be constructed in one region as a steering rack (for engaging a steering pinion), which is to the left or right of the region shown in the drawing. The rod is provided in order to deflect the wheels of a vehicle, which are not shown, over steering tie rods, which are also not shown. The stator 2 is firmly connected with a housing part 6. The hollow shaft 4 is supported by bearings 7, 8 in a housing part, which is not shown, and is connected torque-proof with a pulley 9, which has a driving outer contour, by means of which torque is transferred to a belt 10, which is part of an intermediate transmission. The belt transfers the driving moment of the electric motor 1 to a first gear wheel (pulley 11), which is connected torque-proof with an intermediate shaft 12. The intermediate shaft 12 is supported in the housing 6 and provides a positive connection between the pulley 11 and a further gear wheel (pulley 13), which is also connected torsion-proof with the intermediate shaft. At least one of the pulleys 11, 13 can be connected in one part with the intermediate shaft 12.

A further belt 14 transfers the torque from the pulley 13 to the outer contour of a pulley 15, which is also connected torque-proof with a ball-and-nut 16 of a roll body worm gear (in the example, ball-and-nut worm gear.) The ball-and-nut 16 is supported coaxially with the electric motor (rotatable, but, essentially, not displaceable in the longitudinal direction) in the housing 6 and, by means of a not visible screw on the rod 5, converts the torque into an axial force on the rod 5, which is supported so that it can be displaced in the longitudinal direction but essentially cannot be rotated.

The mode of functioning of the ball-and-nut worm gear, especially ball revolution, is adequately known from the general state of the art. In this connection, reference is made, for example, to the DE 103 10 492 A1.

The parts 9 to 15 identified above, form the above-mentioned intermediate transmission in the form of a belt and chain-driven transmission. In this connection, the outer contours of the parts 9, 11, 13, 15 are fitted to the inner contours of the belt and chain drives 10 and 14 (for example, toothed if a toothed belt is used).

In FIG. 1, the right end of the intermediate shaft 12 is freely accessible, so that it is possible to dispose a permanent magnetic angular position probe 17 there, the field direction of which is indicated by the arrow N (the corresponding prior art is disclosed, for example, in the DE 100 17 061 A1; angular position probes of other types, such as a breaker plate, incremental encoder, etc., are, however, also conceivable).

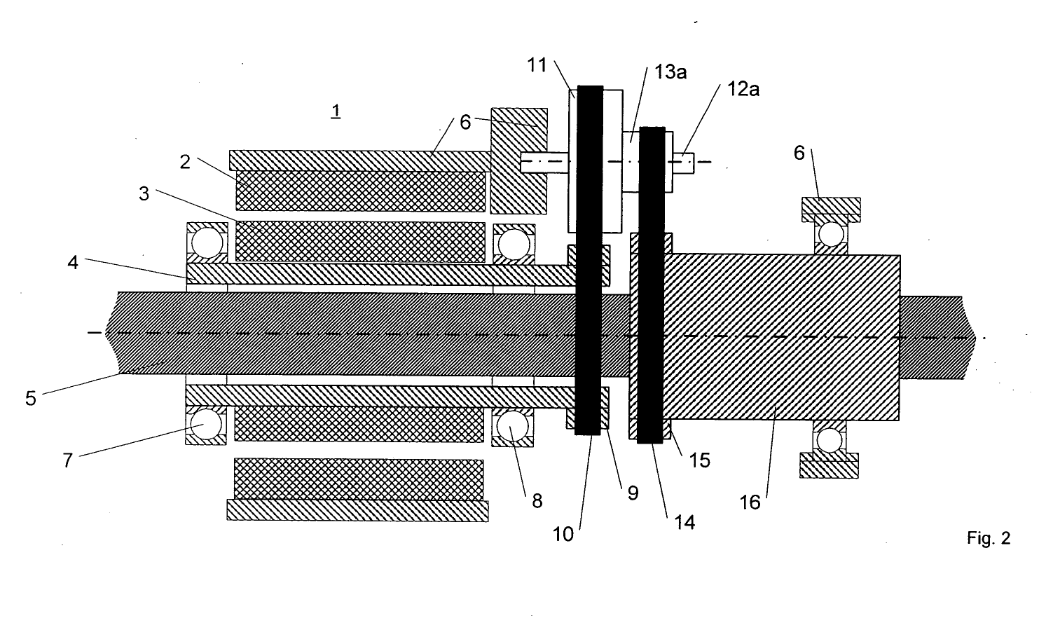

FIG. 2 differs from FIG. 1 in that the two gear wheels (pulleys 11 and 13a) are permanently connected directly with one another and not with an intermediate shaft. In particular, they are produced in one piece and disposed rotatably on a stationary axle 12a.

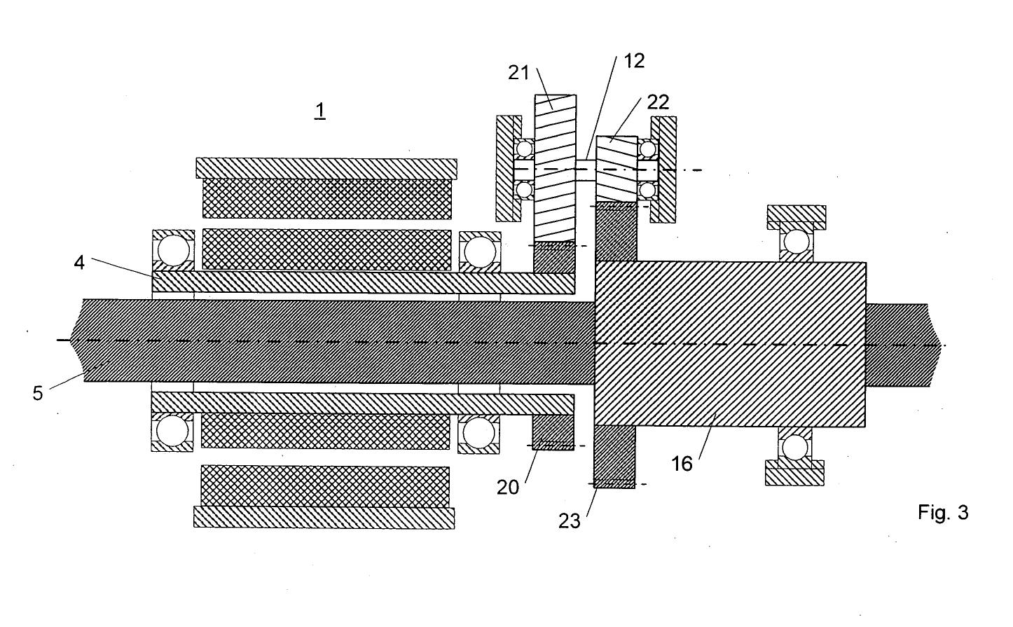

FIG. 3 shows an example according to the invention, for which the intermediate transmission is constructed as a spur gear transmission, for which the outer contours of spur gears 20, 21, 22, 23, which transfer the torques, are toothed. Analogously to FIG. 1, the spur gears 21 and 22 are disposed torque-proof on a common intermediate shaft 12. The spur gear 20 is connected torque-proof with the hollow shaft 4 and spur gear 23 is connected torque-proof with the nut 18. To reduce noise, the outer contour of at least one of the spur gears may optionally be elastic.

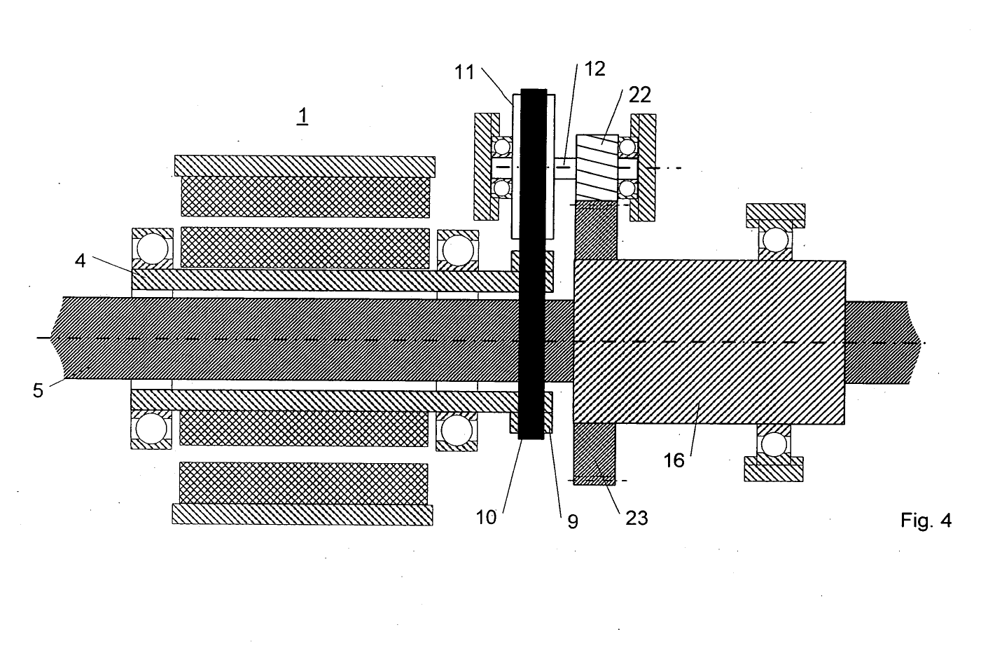

FIG. 4 shows a combination of parts of the intermediate transmission of FIGS. 1 and 2. The left side of the intermediate transmission 9, 10, 11, 12, 22, 23 is constructed as a belt and chain drive transmission step 9, 10, 11 and the right side as a spur wheel transmission step 22, 23.

1.-12. (canceled)

13. A steering system, comprising:
an electric motor including a hollow shaft;
a rod which passes through said hollow shaft;
a worm gear including a worm being carried on the rod, said worm gear further including a nut having a nut outer contour connected torque-proof therewith for receiving torque; and
an intermediate transmission operable to reduce an rpm of the electric motor, the hollow shaft being connected torque-proof with a driving outer contour which transfers torque to the intermediate transmission, the intermediate transmission including a first gear wheel having a first gear wheel outer contour to which torque from the driving outer contour is transferred, the intermediate transmission further including a second gear wheel connected torque-proof with the first gear wheel and having a second gear wheel outer contour that transfers torque to the nut outer contour, said first and second gear wheels having an axle which is essentially stationary relative to a housing part of the steering system, such that said nut is drivable by the intermediate transmission to impart longitudinal movement to said rod in two longitudinal directions thereof by the electric motor acting through the intermediate transmission and the worm gear.

14. A steering system according to claim 13, wherein the transmission ratio between the rpm of the electric motor and the longitudinal movement of the rod is adapted to the requirements of a front wheel steering system or of a rear wheel steering system of a motor vehicle.

15. A steering system according to claim 13, wherein the worm gear is a roll body worm gear.

16. A steering system according to claim 13, wherein the worm gear is a roll body worm gear.

17. A steering system according to claim 14, wherein the worm gear is a roll body worm gear.

18. A steering system according to claim 13, wherein:
the steering system is a power steering system; and
at least one of the first or second gear wheels is part of a belt and chain drive transmission.

19. A steering system according to claim 14, wherein:
the steering system is a power steering system; and
at least one of the first or second gear wheels is part of a belt and chain drive transmission.

20. A steering system according to claim 13, wherein:
the steering system is a power steering system; and
at least one of the first or second gear wheels is part of a belt and chain drive transmission.

21. A steering system according to claim 14, wherein:
the steering system is a power steering system; and
at least one of the first or second gear wheels is part of a belt and chain drive transmission.

22. A steering system according to claim 13, wherein at least one of the outer contours is toothed.

23. A steering system according to claim 14, wherein at least one of the outer contours is toothed.

24. A steering system according to claim 22, wherein the surface of at least one of the outer contours includes an elastic material.

25. A steering system according to claim 23, wherein the surface of at least one of the outer contours includes an elastic material.

26. A steering system according to claim 22, wherein at least one of the first and second gear wheels is a part of a spur wheel gear.

27. A steering system according to claim 13, wherein the first and second gear wheels are coupled directly torque-proof with one another.

28. A steering system according to claim 14, wherein the first and second gear wheels are coupled directly torque-proof with one another.

29. A steering system according to claim 27, wherein the first and second gear wheels are connected torque-proof with one another over an intermediate shaft.

30. A steering system according to claim 28, wherein the first and second gear wheels are connected torque-proof with one another over an intermediate shaft.

31. A steering system according to claim 29, wherein the intermediate shaft is constructed in one piece including at least one of the first or second gear wheels.

32. A steering system according to claim 30, wherein the intermediate shaft is constructed in one piece including at least one of the first or second gear wheels.

33. A steering system according to claim 29, wherein at least one end of the intermediate shaft is freely accessible.

34. A steering system according to claim 30, wherein at least one end of the intermediate shaft is freely accessible.

35. A steering system according to claim 31, wherein at least one end of the intermediate shaft is freely accessible.

36. A steering system according to claim 32, wherein at least one end of the intermediate shaft is freely accessible.

37. A steering system according to claim 29, further comprising an angular position probe which is disposed on the intermediate shaft.

38. A steering system according to claim 30, further comprising an angular position probe which is disposed on the intermediate shaft.

39. A steering system according to claim 31, further comprising an angular position probe which is disposed on the intermediate shaft.

40. A steering system according to claim 32, further comprising an angular position probe which is disposed on the intermediate shaft.

41. A steering system according to claim 33, further comprising an angular position probe which is disposed on the intermediate shaft.

42. A steering system according to claim 34, further comprising an angular position probe which is disposed on the intermediate shaft.

43. A steering system according to claim 35, further comprising an angular position probe which is disposed on the intermediate shaft.

44. A steering system according to claim 36, further comprising an angular position probe which is disposed on the intermediate shaft.
